(19) United States
(12) Patent Application Publication
(10) Pub. No.: US 2012/0098654 A1
(43) Pub. Date: Apr. 26, 2012

(54) Heavy equipment proximity sensor

(76) Inventor: William Ebert, Tucson, AZ (US)

(21) Appl. No.: 12/925,506

(22) Filed: Oct. 23, 2010

(51) Int. Cl. B60Q 1/00

(52) U.S. Cl. 340/438

(57) ABSTRACT

A safety system for an ore processing facility using a mobile mechanisms such as dozer-type wheeled vehicles operating in proximity with an excavator providing ore to a remote milling site. Each mobile mechanism employs a transmitter transmitting a signal on a first frequency which is sensed by the excavator and placed on a display to avoid collisions between the two. The excavator also monitor for lost teeth from the scoop using another sensor/transmitter combination and warns the operator is a tooth is lost.

When the operator of the excavator is given the added task of monitoring the excavator for breakage, the task can become overwhelming. The predominate breakage which may occur is the loss of a tooth and/or an adapter from the excavator dipper itself fails and is lost into the ore being excavated.

The broken tooth with or without the adapter is capable of “jamming” the milling operation and shut the whole process down. Further, to clear the crusher, people must enter the crusher) to remove the jammed tooth which places these people in danger. With the tooth and/or the adapter missing, the dipper can also be damaged.

It is clear there is a need for improved safety relative to heavy equipment

### SUMMARY OF THE INVENTION

The present invention provides for a safety system for an entire ore processing facility together with monitors with alarms to sense unsafe conditions so that the operators are alerted.

In this context, in the fully employed system, three systems operate interactively in a safe environment. These systems are: the excavation mechanism or principal mechanism; the mobile units such as the rubber tired dozers; and the crusher which processes the ore.

Each of the mobile units is controlled by an operator. The mobile unit is equipped with a transmitter well known to those of ordinary skill in the art. Examples of such transmitters are described in: U.S. Patent publication no. US 2006/0033662 published on Feb. 16, 2006, entitled “Location System” for Ward et al.; U.S. Patent publication US 2009/0079633 published on Mar. 26, 2009, entitled “Calibration of a Location System” for Ward; U.S. Pat. No. 7,636,062, entitled “Location Device and System Using UWB and Non-UWB Signals” issued to Ward et al. on Dec. 22, 2009; U.S. Patent publication no. 2010/0001905 published on Jan. 7, 2010, entitled “Location System” for Ward et al.; and, U.S. Pat. No. 7,466,224, entitled “System for Detecting Intruders in a Populated Space” issued to Ward et al. on Dec. 16, 2008; all of which are incorporated hereinto by reference.

In some embodiments, the transmitters are worn by the operator of the mobile units. In this manner, the human operator is also protected even when they are not in the mobile unit. One such application places the transmitters on a pendant which is hung around the neck of the operator.

These transmitters generate a signal at a chosen or prescribed frequency. By using a designated frequency, interference or mis-identification is minimized.

Those of ordinary skill in the art readily recognize techniques to vary the frequency of the transmitters, including, but not limited to: U.S. Pat. No. 7,599,715, entitled “System and Method for Matching Wireless Devices” issued to Himmelstein on Oct. 6, 2009; and U.S. Patent publication number US 2008/0039023 entitled “Tag Frequency Control” published on Feb. 14, 2008, for Ward; both of which are incorporated hereinto by reference.

An excavation mechanism is the principal mechanism within the assembly. The excavator mechanism is adapted to excavate earth/ore and place it into dump trucks while he mobile mechanism “police” the area to keep the site orderly.

The excavation mechanism includes an array of sensors positioned around it to receive the signals from the transmitters on the mobile devices. These signals are processed and a display within the excavation mechanism identifies where each of the mobile mechanisms is relative to the excavation mechanism. Should a mobile mechanism “move” into a proscribed zone relative to the excavation mechanism, an alarm/warning is sounded within the excavation mechanism to warn its operator.

Those of ordinary skill in the art recognize a variety of mechanisms which monitor transmitters and produce appropriate warnings, including, but not limited to: U.S. Pat. No. 7,586,405, entitled “Motorcycle Awareness System” issued to Brandenburg on Sep. 8, 2009; U.S. Pat. No. 7,592,944, entitled “System and Method for Intrusion Detection Using a Time Domain Radar Array” issued to Fullerton et al. on Sep. 22, 2009; U.S. Pat. No. 7,598,848, entitled “Apparatus and Method of Pedestrian Recognition” issued to Takagi et al. on Oct. 6, 2009; U.S. Pat. No. 7,598,850, entitled “System and Method for Centralized Even Warning Notification for Individual Entities, and Computer Program Product Therefor” issued to Manz on Oct. 6, 2009; and, U.S. Pat. No. 7,603, 215, entitled “Lan Keep Control Apparatus and Method for Automotive Vehicle” issued to Matsumoto et al. on Oct. 13, 2009; all of which are incorporated hereinto by reference.

In this context, the earth moving/excavation mechanism has a display which uses a network of sensors positioned on the excavator. The signals from the transmitter on the mobile mechanisms are received by the network of sensors and the locations of the mobile mechanisms relative to the ecavator is displayed for the operator of the excavation mechanism to monitor their positions so that collisions can be avoided.

Another embodiment of the invention allows the operator of the excavation mechanism to define a proscribed zone which amounts to a heighten danger field. If a mobile mechanism moves into this proscribed area, an audible alarm, light, or voice telling the operator is sounded and preferably indicating if the danger is in front, left, right, or rear, thereby allowing immediate action to be taken by the operator of the excavation mechanism.

In this embodiment, a further enhancement uses a radio to automatically warn the operator of the mobile mechanisms as well. This is accomplished using a variety of techniques well known to those of ordinary skill in the art, including, but not limited to: U.S. Pat. No. 7,596,391, entitled “System and Method for Wireless Communication Between a Vehicle and a Mobile Unit” issued to Himmelstein on Sep. 29, 2009; and, U.S. Pat. No. 7,603,080, entitled “Multiple Channel Wireless Communication System” issued to Richenstein et al. on Oct. 13, 2009; both of which are incorporated hereinto by reference.

Even further, in the preferred embodiment, transmitters are also planted on the teeth of the excavator mechanism used to excavate the ore. A specified sensor is directed towards the teeth on the excavator's dipper and the presence of the teeth are monitored (via the transmitters). Should a tooth's transmitter not be sensed (indicating that the tooth and/or the adapter associated therewith has been broken from the excavator dipper and placed in one of the dump trucks) an alarm is sounded in the excavation mechanism so that the affected load may be diverted from the crushing operation.

Further, at the remote ore processing mechanism, another sensor monitors the incoming ore loads and monitors for the presence of a transmitter. This provides another layer of protection so that the hardened tooth or adapter does not get into the ore crusher and jam it.

If a tooth is sensed going into the crusher, an alarm is given and the offending tooth is removed or diverted.

Ideally the transmitters on the teeth are communicating on their own frequency so that only the teeth are being sensed.

The invention, together with various embodiments thereof will be more fully explained by the accompanying drawings and the following descriptions thereof.

### DRAWINGS IN BRIEF

FIG. 1 illustrates an excavation mechanism with the preferred embodiment's array of sensors.

FIG. 2 illustrates the monitor which is mounted within the cab of the excavator.

FIG. 3 illustrates a wheeled vehicle equipped with a transmitter and a receiving radio for alarms from the excavator mechanism.

FIG. 4 illustrates a safety mechanism for an individual.

FIG. 5 illustrates the excavator dipper with teeth/adapters of the excavation mechanism having transmitters therein.

FIG. 6 shows the monitoring at the crusher location for any broken teeth/adapters.

FIG. 7 is a system diagram showing the overall safety system of the preferred embodiment.

### DRAWINGS IN DETAIL

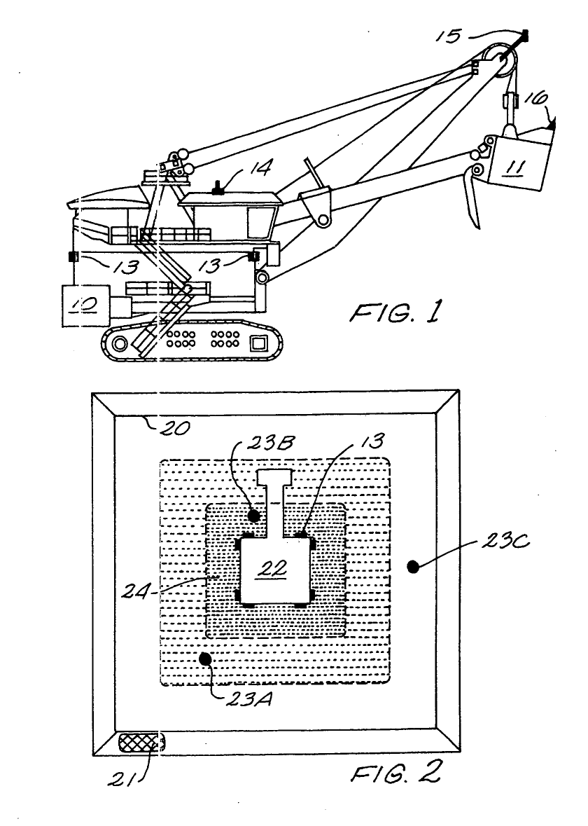

FIG. 1 illustrates an excavation mechanism with the preferred embodiment's array of sensors.

Excavator 10 is used for the excavation of ore and uses dipper 11 which removes ore to be placed into a dump truck (not shown). To assist in the excavation process, dipper 11 uses a number of teeth 16 which rip into the ore face.

Excavator mechanism 10 is a massive mechanism which requires great concentration by its operator. To monitor nearby mechanisms and personnel, sensors 13 are arranged around excavator 10 to locate the transmitters and then plot and monitor the transmitter's movement relative to excavator 10.

Further, in some embodiments of the invention, excavator 10 uses radio transmission via antenna 14 to warn nearby vehicles/personnel of a sensed dangerous situation.

In another embodiment of the invention, sensor 15 is directed towards tooth 16 which includes a transmitter embedded therein. If a transmission is not present (indicating that tooth 16 is missing from dipper 11), as noted by sensor 15, a computer or microprocessor (not shown) alerts the operator so that the loose tooth or adaptor is prevented from entering the crushing operation and jamming the equipment therein.

FIG. 2 illustrates the monitor which is mounted within the cab of the evacuator mechanism.

Monitor 20 shows a stationary stylized excavator 22. The various other vehicles or personnel 23A, 23B, and 23C, are shown on monitor 20. A danger zone 24 is represented or the screen so that if a mobile mechanism 23B enters the danger zone 24, an alarm or voice is sounded via speaker 21. In some embodiments, speaker 21 is remotely located.

In another embodiment, a warning flashes the symbol for mobile mechanism 23B in a red or highlighted color on the display.

Note, movement in this context is all relative to excavator 22. As example, mobile mechanism 23B may be stationary on the ground, but, as excavator 22 “swings” around, there will be relative motion between the two objects and it will appear that mobile mechanism 23B is “moving” into the danger zone 24 when in reality the danger zone 24 is being swept toward mobile mechanism 23B.

In this manner, the operator of excavator 22 is warned of dangerous situations and can take remedial actions.

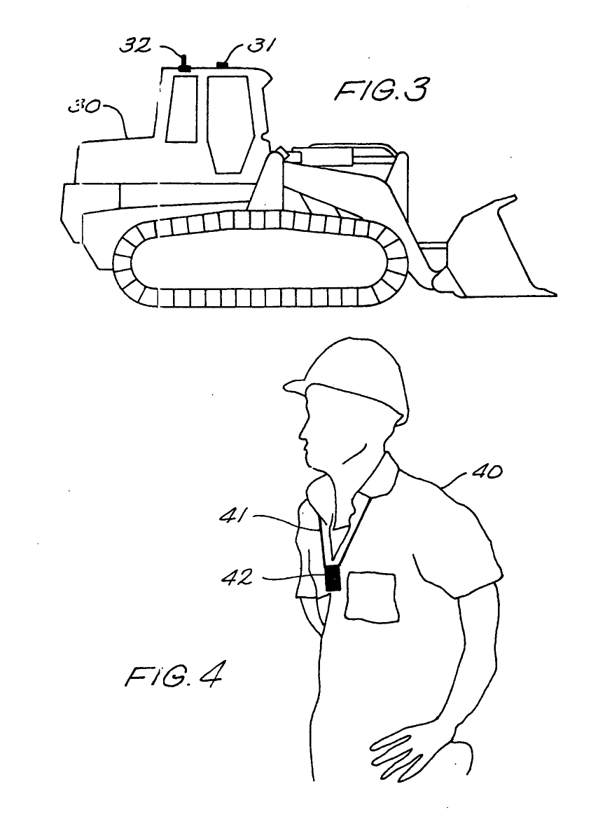

FIG. 3 illustrates a track vehicle equipped with a transmitter and a receiving radio for alarms from the evacuator mechanism. The illustration shows a track vehicle but the invention is not to be limited thereby; the invention also includes wheeled vehicles.

Mobile mechanism 30 is equipped with a transmitter 31 (mounted on the cab of the vehicle in this illustration). It is transmitter 31 which is picked up and monitored by the sensors on the excavator as described earlier.

Note, while this illustration shows a dozer-type of mechanism, the invention is not so limited but includes other mobile mechanisms well known to those of ordinary skill in the art, including, but not limited to pickup trucks.

In the preferred embodiment, should mobile mechanism 30 enter a danger zone relative to the excavation mechanism, then a radio warning is transmitted by the excavation mechanism. This radio warning is picked up by the mobile mechanism 30 via antenna 32 and the operator of the mobile mechanism 30 is alerted so that a collision can be avoided

FIG. 4 illustrates a safety mechanism for an individual.

User 40 has transmitter/ radio receiver 42 secured around his neck using lanyard 41. Other embodiments use a clip on mechanism for the belt for the placement of the transmitter/radio receiver 42. Those of ordinary skill in the art recognize a variety of other attachment mechanisms which can be used in this context.

In this embodiment, should user 40 enter into the danger zone as described above (whether user 40 is operating the mobile mechanism or is walking), the excavation mechanism, sensing user 40's presence, alerts user 40 via a radio transmission which sounds on transmitter/radio receiver 42. In some embodiments, excavation is halted during an alarm situation.

This embodiment is useful because it allows individuals to be protected when near the excavator mechanism and also eliminates the need to modify the mobile mechanisms when the operator wears this safety mechanism.

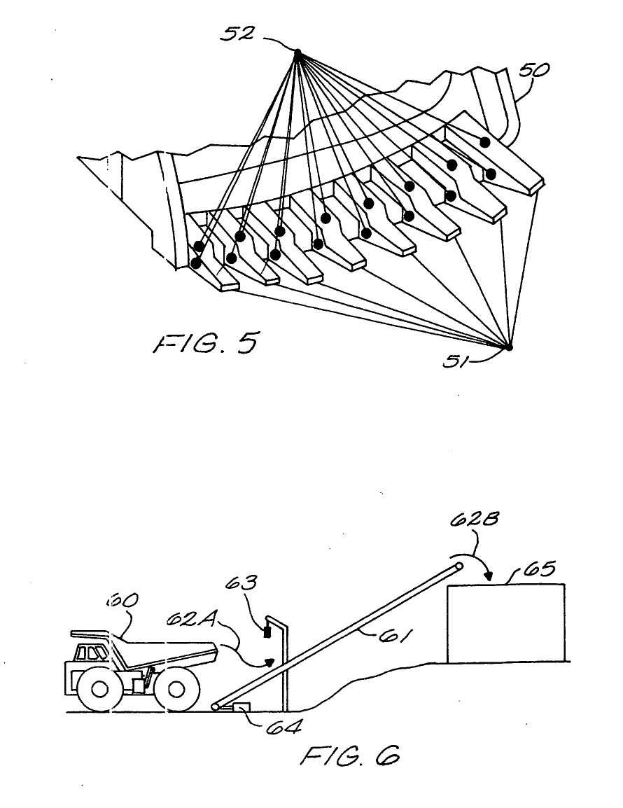

FIG. 5 is a top view of an excavator bucket and illustrates the bucket with teeth/adapters having transmitters therein.

Scoop 50 has teeth 51 secured thereon using adapters 52. In this illustration, each tooth 51 is equipped with two transmitters 52; other embodiments employ a single transmitter and still others employ more than two transmitters. These transmitters 52 are monitored as outlined earlier to determine if a tooth and/or adapter has been broken from the bucket.

The teeth are made of such hardened metal that a broken tooth can easily jam the crusher used to crush the ore.

FIG. 6 shows the monitoring at the mill location for any broken teeth/adapters

In a typical mining operation, dump truck 60 deposits the ore as indicated by arrow 62A onto conveyor belt 61 which is powered by motor 64. The deposited ore is transported by conveyor belt 61 to the crusher or mill 65 as illustrated by arrow 62B.

Ideally, during transportation of the ore by conveyor belt 61, sensor 63 monitors for the existence of a transmitter as outlined in FIG. 5, being attached to a broken tooth. If this transmitter is sensed by sensor 63, motor 64 is stopped and the tooth is found and removed from the ore on conveyor belt 61. This prevents the broken tooth from entering and jamming the crushing operation.

In a different embodiment, an alarm is sounded to alert the operator of the mill of the tooth's existence within the ore on conveyor belt 61.

In yet another embodiment, when the existence of the tooth is made, a diversion of the ore is made to a debris field where the broken tooth can be removed at a later time; thereby allowing crusher 65 and the conveyor belt 61 to continue operation.

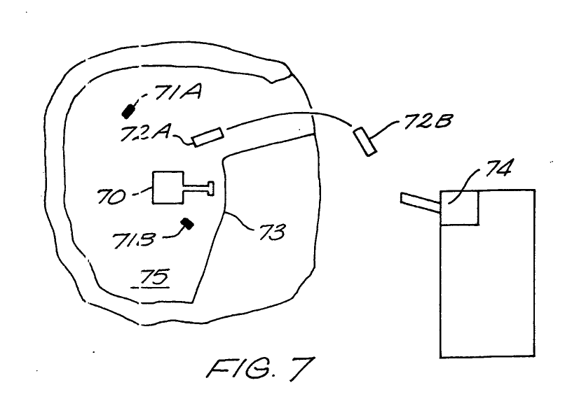

FIG. 7 is a system diagram showing the overall safety system of the preferred embodiment.

In this complete safety system, excavation mechanism 70 removes ore from an excavation face 73 within excavation pit 75. Ore from excavation mechanism 70 is deposited into dump truck 72A and transported to crusher 74 as illustrated by dump truck 72B.

Wheeled vehicles 71A and 71B operate around the excavation mechanism 70 to keep the area debris free so that dump trucks' tires 72A and 72B are not damaged by fallen rocks.

Using the transmitters and sensors as outlined above, wheeled vehicles 71A and 71B are monitored by excavation mechanism 70 for safety and crusher 74 monitors the ore being delivered by dump trucks 72A and 72B for broken teeth or adaptors from excavation mechanism 70.

In this manner, the entire system is provided protection from damage both to the operators and also to the mechanisms involved.

It is clear that the present invention provides for a highly improved safety system ideally suited for heavy equipment.

What is claimed is:

1. A safety system for an ore processing facility comprising:
a) a mobile mechanism having an operator therein and having a transmitter transmitting a signal on a first frequency;
b) an earth moving mechanism having,
1) a display,
2) a network of sensors positioned on said earth moving mechanism such that signals from the transmitter on said mobile mechanism are received by said network of sensors and based thereon, a position of said mobile mechanism relative to said earth moving mechanism is displayed on said display;
3) a scoop for withdrawing dirt, said scoop having at least two teeth thereon, each of said teeth having at least one transmitter transmitting on a second frequency,
4) a presence sensor directed towards said at least two teeth, and,
5) an alarm, responsive to signals from said presence sensor when a transmitter on one of said teeth is not sensed by said presence sensor; and,
c) A remote ore processing mechanism having,
1) a sensor configured to identify the presence of a transmitter communicating on the second frequency, and,
2) an alarm being responsive to the existence of signals from said sensor.

2. The safety system for ore processing facility according to claim 1, wherein said alarm on said earth moving mechanism is further activated if the transmitter associated with said mobile mechanism moves into a prescribed range relative to said earth moving mechanism.

3. The safety system for ore processing facility according to claim 2, wherein:
a) said earth moving mechanism includes a radio transmitter communicating a warning when said alarm is activated due to the presence of said transmitter on said mobile mechanism within the prescribed range; and,
b) said mobile mechanism includes a radio receiver communicating with said radio transmitter on said earth moving mechanism to sound said warning.

4. The safety system for ore processing facility according to claim 3, wherein each of said at least two teeth contains at least two transmitters.

5. A safety system comprising:
a) at least one mobile mechanism being operator controlled, each mobile mechanism having associated therewith a transmitter generating a signal; and,
b) a primary mechanism having an operator therein, said primary mechanism having a display and a network of sensors, said network of sensors positioned on said primary mechanism such that signals from each transmitter on said at least one mobile mechanisms are received by said network of sensors and a position relative to said primary mechanism of each of said mobile mechanisms is displayed on said display.

6. The safety system according to claim 5, wherein said transmitter of said at least one mobile mechanism is secured to an operator of the mobile mechanism.

7. The safety system according to claim 6, wherein said transmitter is configured to be hung around the operator's neck.

8. The safety system according to claim 5, wherein said primary mechanism includes an alarm and wherein said alarm is activated if one of said transmitters is within a prescribed range relative to said primary mechanism.

9. The safety system according to claim 8, wherein:
a) each of said at least one mobile mechanisms includes a radio receiver, each radio receiver receiving at a unique frequency; and,
b) said primary mechanism includes a radio transmitter communicating a warning at a frequency associated with a mobile mechanism within said prescribed range.

10. The safety system according to claim 5, wherein said primary mechanism further includes:
a) a scoop for withdrawing dirt, said scoop having at least two teeth thereon, each of said teeth having at least one transmitter therein;
b) a scoop presence sensor directed towards said at least two teeth; and,
c) wherein said alarm is responsive to signals from said scoop presence sensor when a transmitter on one of said teeth is not sensed by said scoop presence sensor.

11. The safety system according to claim 10, wherein said transmitters in said teeth communicate at a prescribed frequency.

12. The safety system according to claim 11 further including a remote ore crushing mechanism having,
a) a stationary sensor monitoring for a transmitter communicating on the prescribed frequency; and,
b) an operation curtailment mechanism being responsive to signals from said stationary sensor for curtailing operation of said crushing mechanism.

13. A safety system for a crusher comprising:
a) a sensor monitoring a flow of ore into the mill, said sensor being reactive to a transmitter communicating at a prescribed frequency within said flow of ore; and,
b) an alarm being responsive to signals from said sensor.

14. The safety system for a crusher according to claim 13, further including n earth moving mechanism having:
a) a scoop for withdrawing dirt, said scoop having at least two teeth thereon, each of said teeth having at least one transmitter communicating at said prescribed frequency;
b) a presence sensor directed towards said at least two teeth; and,
c) an alarm being responsive to signals from said presence sensor when one of said transmitters is not sensed.
